(19) United States
(12) Patent Application Publication
(10) Pub. No.: US 2009/0013657 A1
(43) Pub. Date: Jan. 15, 2009

(54) Adjustable saddle

(76) Inventors: Kristi L. Kesick, Plymouth, WI (US); Keith R. Kesick, Plymouth, WI (US)

Correspondence Address: RYAN KROMHOLZ & MANION, S.C., POST OFFICE BOX 26618, MILWAUKEE, WI, 53226, US

(21) Appl. No.: 12/075,984

(22) Filed: Mar. 14, 2008

Related U.S. Application Data
(60) Provisional application No. 60/906,894, filed on Mar. 14, 2007.

(51) Int. Cl. B68C 1/04

(52) U.S. Cl. 54/44.3

(57) ABSTRACT

An adjustable saddle and saddle tree assembly including an adjustable pommel frame assembly in communication with the saddle side bars whereby lateral adjustment of the adjustable pommel frame assembly effectively adjusts the lateral spacing of the saddle bars and thereby the overall fit of the saddle.

### RELATED APPLICATIONS

This application claims the benefit of co-pending U.S. Provisional Patent Application Ser. No. 60/906,894, filed 14 Mar. 2007.

### BACKGROUND OF THE INVENTION

The present invention is broadly concerned with an improved saddle and saddle tree assembly which is adjustable to accommodate the physical characteristics of a particular animal, such as a horse, to be saddled. Specifically, it is concerned with an adjustable tree assembly having an adjustable pommel frame assembly permitting relative, lateral adjustment of the saddle tree side bars.

Most problems associated with saddle fitting are due to the wide variation in animal size and shape. If a saddle is improperly fit to an individual animal, comfort of the animal is compromised and animal performance is compromised. A fairly wide range of sizes can be accommodated with a well-designed tree. A limited amount of adjustment is achieved by varying the thickness of saddle pads or blankets. When the saddle is moderately too wide extra padding may be added, but if the saddle is too narrow, the pressure will create muscle atrophy as well as acute, then chronic, pain in the horse unless the tree is widened. It is essential to avoid pressure points since prolonged use of a saddle which creates pressure points will result in injury to the horse. The traditional, limited amount of fit customization accomplished by way of various thicknesses of pads or blankets used under the saddle has limited practicality and can cause instability in the saddle and thereby in the rider. Since fitting the animal, such as a horse, is of utmost importance for comfort and performance, saddles typically come in a variety of sizes to allow proper fit for horse and rider. If a saddle fits poorly, it creates the aforementioned discomfort for the horse as well as imbalance for the rider.

Another related problem is that, over time, each individual animal displays ongoing and considerable variation in musculature across the back. This variation depends on age, current training status and overall health, among other factors. Animals, such as horses, that are trained extensively typically exhibit a well developed musculature that changes as fitness increases. Additionally, if training decreases, the back musculature will also change accordingly. In some cases the animal may be put into and out of training depending on the weather, season or showing schedule. Further, as an animal matures, the size and shape of the back will also change. A change in feed or other living conditions may further reflect itself in the overall musculature and thereby shape of an animal's back. This will further affect saddle fit.

In saddle construction three main elements are: the tree, the seat and the rigging. If all three are properly designed and constructed, the result is a good, useful saddle, regardless of style and aesthetics. If any one of these is wrong or poorly done, the saddle is of little value. The tree is the main component of saddle infrastructure. In a typical saddle tree, the essential parts are two side bars, placed parallel to the horse's spine, with an arch clearing the backbone and attached near each end of the two side bars to thereby give integrity to the whole structure. The shape and structure of the side bars determine how well the tree fits the type of back for which it is intended. Additional components of the saddle structure are built around the tree and are covered with acceptable cladding such as leather or synthetic material.

In this way, since each saddle is relatively custom fit to an individual horse, each horse ordinarily requires its own saddle. This can become expensive when riders use multiple horses. Further, and as previously mentioned, as a horse matures and develops through training, its musculature through the back may also change, thereby requiring saddle adjustment or even a new saddle to fit its new shape. Thus, a saddle having means for adjustable fitting is desired.

### SUMMARY OF THE INVENTION

The present invention overcomes the problems described above and provides an improved saddle and saddle tree assembly. More specifically, the present invention is directed to an adjustable saddle tree assembly having an adjustment mechanism which permits variation in fit relative the animal to be saddled by providing lateral adjustment of the side bars. Lateral adjustment of the side bars thereby provides variation in fit to accommodate multiple horse sizes. The tree of the present invention includes flexible side bars and an adjustable pommel frame assembly, whereby the flexible side bars may be positioned laterally relative one another to thereby provide proper fit.

In more detail, the adjustable tree of the present invention includes a pair of laterally spaced apart side bars. The side bars may be formed of flexible material. The side bars are conventionally adapted to lay on either side of the animal's spine, and to form the basis for the saddle tree. Adjustability is accomplished primarily by way of an adjustable pommel frame assembly.

The adjustable pommel frame assembly preferably includes a generally curved, arcuate, C-shaped member which terminates in laterally spaced apart ends. Each end of the arcuate, C-shaped member is pivotally attached to the proximal end of an adjustment arm. The distal end of each adjustment arm is adapted to be secured to a respective flexible side bar via a bracket member located at a forward point on the side bar. The proximal end of each adjustment arm is attached to the curved, C-shaped member by way of pivot points.

Adjustability of the pommel frame assembly is provided by means of pivot members at the pivot points. Each respective pivot member passes through both a respective arm at its proximal end, and the C-shaped member at its distal end to thereby pivotally attach each arm member to a respective C-shaped member distal end. In this manner, each arm is rotatable relative to the C-shaped member while being fixed against axial movement. Relative rotation of each arm is moderated by way of a threaded adjustment screw member. Each adjustment screw passes through a side wall of a respective arm and associated C-shaped member distal end. Rotation of the screws influences movement of the arms relative the C-shaped member, and consequentially, movement of the side bars to which the arms are connected by way of the aforementioned bracket structures. Thus the arms are laterally rotatable relative to a pivot point, with range of movement being set and limited by screw tension. The pivot points allow the arms to be rotated laterally while screws adjust the arc of pivot.

In particularly preferred forms of the present invention, the adjustable tree may be for use in the endurance riding discipline, although the concept may be used with other saddle designs as well.

### BRIEF DESCRIPTION OF THE DRAWINGS

FIG. 1 is a perspective view of a saddle according to the present invention, with a horse being shown in phantom.

FIG. 2 is a view of the saddle depicted in FIG. 1, but with partial cutaways showing the adjustable pommel frame assembly and flexible side bar in their positions relative the saddle.

FIG. 3 is a side plan view of a side bar and pommel bracket with a fragmentary partially exploded view of the adjustable pommel frame assembly.

FIG. 4 is a front plan view of the adjustable pommel frame assembly.

FIG. 5 is an enlarged perspective view of the area noted generally as 5 in FIG. 1, and showing the access opening whereby the adjustable pommel frame assembly may be adjusted.

FIG. 6 is an enlarged perspective view of the area noted generally as 6 in FIG. 2, and showing the pivot point and adjustable screw.

FIG. 7 is an enlarged fragmentary view of an end of the adjustable pommel frame assembly, and showing relative pivotal movement in phantom.

FIG. 8A is a front plan view of an adjustable saddle according to the present invention in place on an animal's back and showing the adjustable pommel frame assembly and side panels spaced apart a first distance, with cut away illustrating an end of the adjustable pommel frame assembly in place.

FIG. 8B is a front plan view of an adjustable saddle according to the present invention similar to FIG. 8A, but showing the adjustable pommel frame assembly and side panels spaced apart a second, lesser distance.

### DESCRIPTION OF THE PREFERRED EMBODIMENT

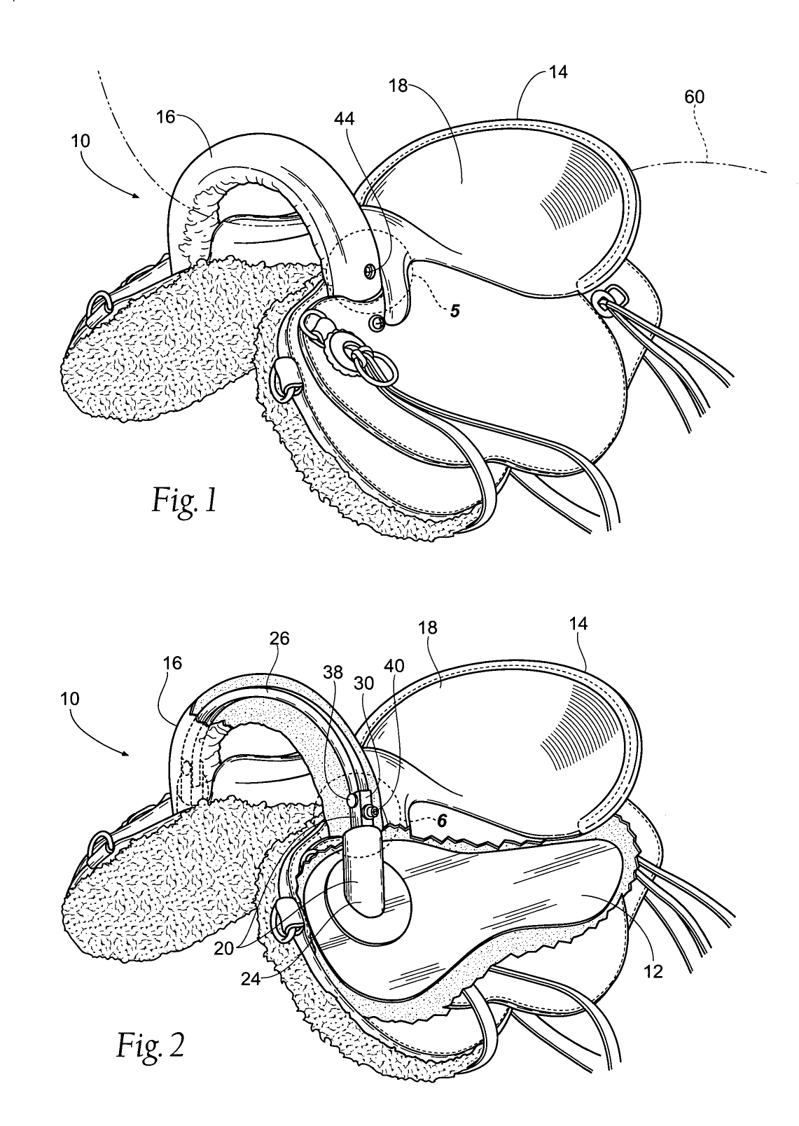

Referring now to the drawings, the adjustable saddle and tree assembly is seen in FIGS. 1 and 2. FIG. 1 illustrates an adjustable saddle 10 in accordance with the present invention. As may be observed, the adjustable saddle 10 includes typical saddle parts and infrastructure, including side bars 12, interconnecting cantle 14 and pommel 16, and seat 18.

Broadly, the present invention is directed to an adjustable saddle tree assembly 20 having an adjustment means which permits variation in fit relative the animal, such as a horse 60 (seen in phantom in FIG. 1) to be saddled, by providing lateral adjustment of the side bars 12. As seen in the Figures, the illustrated saddle style is an endurance saddle that includes a pronounced pommel 16. In particularly preferred forms of the present invention, the improved adjustable tree assembly 20 may be used in the endurance riding discipline, however it is to be understood that the adjustable tree assembly 20 of the present invention may be incorporated into other saddle designs such as English-style saddles, among others.

Most importantly to the present invention, the adjustable tree assembly 20 includes a pommel 16 formed around an adjustable pommel frame assembly 22 (see FIG. 4) and in communication with the flexible side bars 12. The combination of elements allows the flexible side bars 12 to be positioned laterally relative one another to thereby provide proper fit.

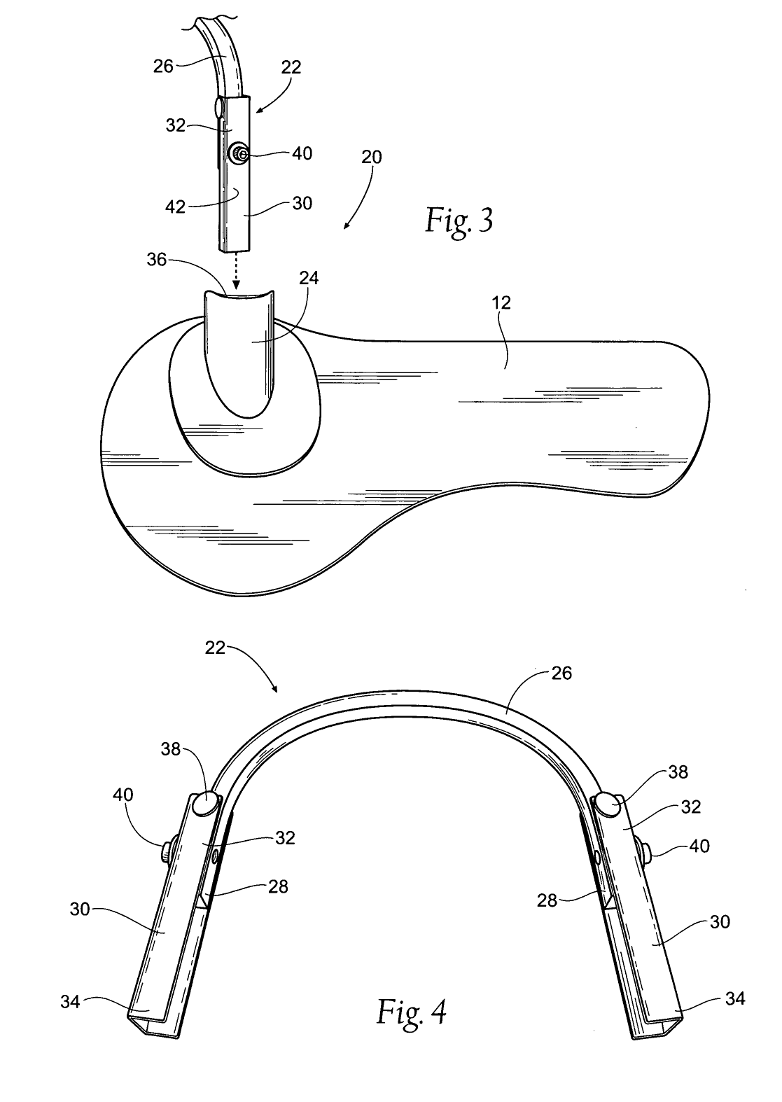

Illustrated in more detail in the views of FIGS. 2-4, some of the key components of the present invention may be seen. As viewed particularly in FIGS. 2 and 3, the adjustable tree of the present invention includes a pair of laterally spaced apart side bars 12 which may be made of any suitable flexible material, such as low density polyethylene, for example, which allows more flex and give than the usual wood bars. The side bars 12 are conventionally adapted to lay on either side of the animal's spine (not seen in these views), and to form the basis for the adjustable saddle tree 20. Specifically, the adjustment structure is composed primarily of an adjustable pommel frame assembly 22 in communication with a pair of bracket structures 24 affixed to the side bars 12.

As viewed particularly in FIG. 4, the adjustable pommel frame assembly 22 preferably includes a generally curved, C-shaped member 26 which terminates in laterally spaced apart ends 28. Each end 28 of the curved, C-shaped member 26 is pivotally attached to the proximal end 32 of an adjustment arm 30. The distal end 34 of each adjustment arm 30 is secured to a respective flexible side bar 12 in a bracket structure 24 located at a forward point on the side bar 12 (see particularly FIG. 3). As may be further viewed in FIGS. 2 and 3, each bracket structure 24 is adapted to retain a distal end 34 of an arm 30 on a respective side bar 12. As seen, the bracket structure 24 may include a retention member 36 which receives the distal end 34 of an arm 30. Each bracket structure 24 is affixed to a respective side bar 12 by way of rivets (not shown) or other acceptable means.

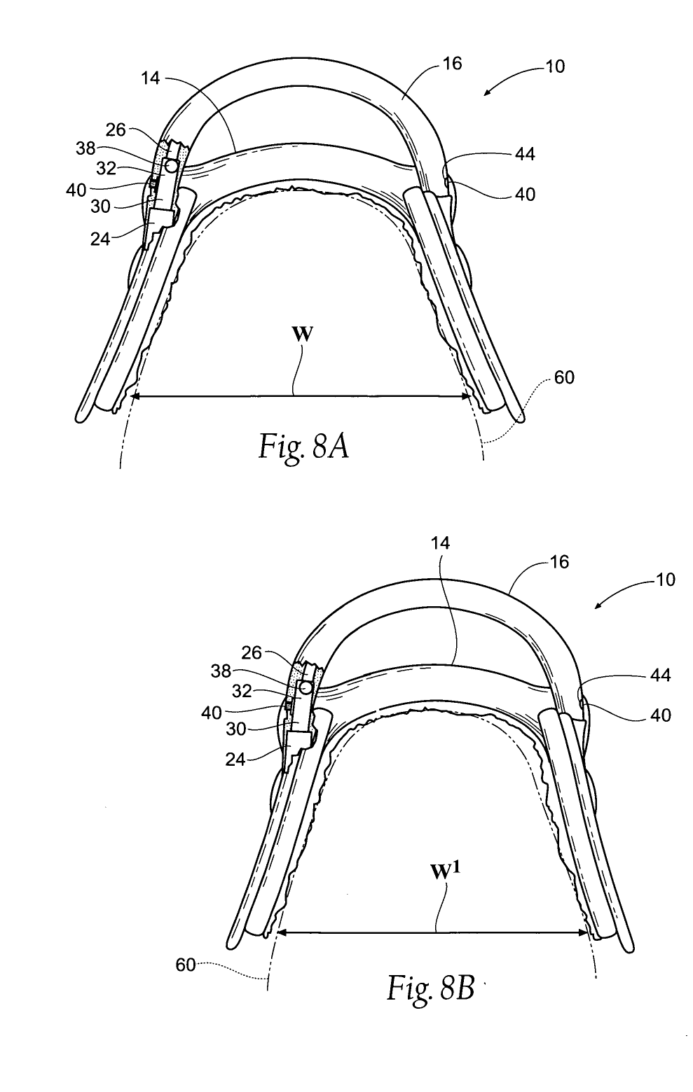

Adjustability of the tree assembly 20 may be observed particularly in FIGS. 7, 8A and 8B. As illustrated, pivotal movement of the adjustable pommel frame assembly 22 occurs through pivot members 38. As illustrated most clearly in FIG. 4, the proximal end 32 of each arm 30 is attached to C-shaped member 26 by way of pivot members 38, each of which passes through a respective arm 30 proximal end 32 and C-shaped member 26 distal end 28. In this manner, each arm member 30 is pivotally attached to a respective C-shaped member 26 distal end 28. As seen particularly in FIG. 7, each arm 30 is rotatable relative the C-shaped member 26 while being fixed against axial movement.

Turning now to FIG. 6, it may be seen that relative rotation of each arm 30 may be moderated by way of a threaded adjustment screw member 40. Each adjustment screw 40 passes through a side wall 42 of a respective arm 30 and associated C-shaped member 26 distal end 28. Rotation of the adjustment screw 40 influences the range of movement of the arms 30 relative to the C-shaped member 26, and consequentially, movement of the side bars 12 to which the arms 30 are connected by way of the aforementioned bracket structures 24. The screws 40 adjust the pivotal arc of each arm 30. Thus the arms 30 are laterally rotatable relative a pivot point, with range of movement being set by screw 40.

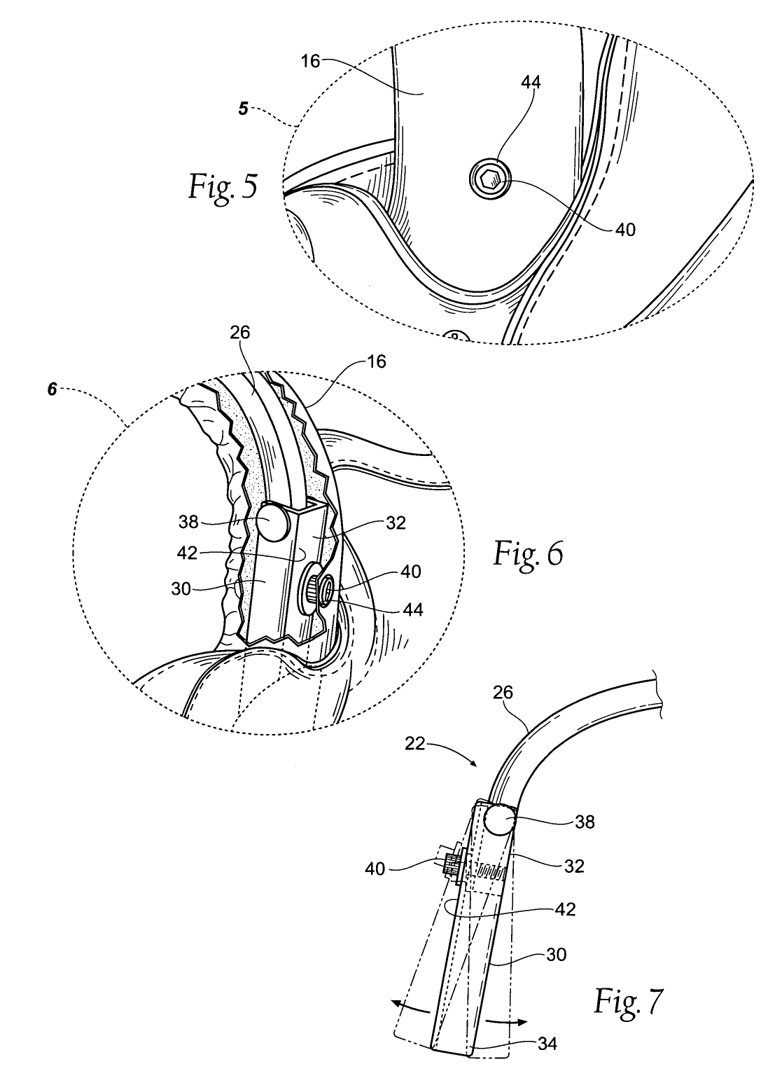

As is illustrated particularly in the enlarged views of FIGS. 5 and 6, the screw 40 may be accessed through opening 44 in the pommel 16 cladding. The opening 44 is preferably provided since in use, the adjustable pommel frame assembly 22 is typically covered in leather, or other acceptable cladding. A suitable adjustment tool, such as an Allen-head wrench (not shown), may then be used to manipulate the screw 40 and thereby adjust the position of the adjustment arms 30 to adjust fit.

The overall effect of the present arrangement may be seen particularly in the views of FIGS. 8A and 8B. As may be observed, since the distal end 34 of each adjustment arm 30 is retained in a respective retention member 36 of bracket 24, lateral positioning of the adjustment arms 30 also positions the side bars 12. This function thereby adjusts the fit of the saddle 10. FIG. 8A shows the adjustable pommel frame assembly 22 and adjustment arms 30, along with side bars 12 as adjusted to provide lateral width W. The similar view of FIG. 8B illustrates the components adjusted to provide a second lateral width W′. Comparison of the views of FIGS. 8A and 8B illustrates the adjustability of the present invention.

I/We claim:

1. An adjustable saddle tree assembly comprising:
a pair of laterally spaced apart side bar members;
a pair of bracket members, each of said bracket members being supported by and laterally extending from a respective one of said pair of side bar members; and
an adjustable pommel frame assembly, said pommel frame assembly having an arcuate shape terminating in laterally spaced-apart ends, said ends being respectively supported by said bracket members, and extending longitudinally endwise relative to said respective bracket members.

2. The adjustable saddle tree assembly of claim 1 including adjustment means arranged to provide lateral movement of at least one of said side bar members.

3. The adjustable saddle tree assembly of claim 2 wherein said adjustment means comprises a pair of adjustment arms, each one of said pair of adjustment arms having a distal end and a proximal end, and wherein the proximal end of each respective adjustment arm is pivotally attached to a respective one of said laterally spaced apart ends.

4. The adjustable saddle tree assembly of claim 3 wherein said adjustable pommel frame assembly further includes means for providing limited lateral pivotal movement of said adjustment arms.

5. The adjustable saddle tree of claim 4 wherein said means for providing limited lateral pivotal movement comprises at least one adjustment screw member, said adjustment screw member passing through a side wall of said adjustment arm and of said end of said pommel frame.

6. The adjustable saddle tree of claim 5 wherein said means for providing limited lateral pivotal movement comprises a pair of adjustment screw members, each one of said pair of adjustment screw members passing through a side wall of said respective adjustment arm and a respective end of said pommel frame.

7. The adjustable saddle tree of claim 1, wherein said bar members are formed of a resilient, flexible material.

8. The adjustable saddle tree of claim 7, wherein said bar members are formed of low density polyethylene.

9. The adjustable saddle tree assembly of claim 1 wherein said pommel frame is of a generally C-shape.

10. A method of providing lateral movement to a saddle side bar comprising:
providing an adjustable saddle tree assembly including an adjustable pommel frame;
providing at least one bracket member laterally extending endwise relative to said saddle side bar;
providing means for attaching and supporting said bracket member to said saddle side bar; and
providing adjustment means for supplying limited lateral movement to said bracket and to said saddle side bar.

11. The method of claim 10 further including the step of providing said adjustable pommel frame assembly with an arcuate shape terminating in laterally spaced apart ends.

12. The method of claim 11 further including the step of supporting at least one of said laterally spaced ends in said at least one bracket member.

13. The method of claim 12 further including the step of providing said at least one laterally spaced end with an adjustment arm, said adjustment arm having a distal end and a proximal end.

14. The method of claim 13 further including the step of pivotally attaching said proximal end to said at least one laterally spaced end.
